(19) United States
(12) Patent Application Publication
(10) Pub. No.: US 2014/0054459 A1
(43) Pub. Date: Feb. 27, 2014

(54) APPARATUS AND METHOD FOR MONITORING A CARD SLOT

(71) Applicant: Kate Scott, Surrey (GB)

(72) Inventor: Kate Scott, Surrey (GB)

(73) Assignee: ATM PARTS COMPANY LTD., Camberley, Surrey (GB)

(21) Appl. No.: 14/000,848

(22) PCT Filed: Feb. 22, 2012
(86) PCT No.: PCT/GB12/50398

§ 371 Date: Oct. 24, 2013

(30) Foreign Application Priority Data
Feb. 22, 2011 (GB) 1103019.4

(51) Int. Cl. G01V 8/12

(52) U.S. Cl. CPC G01V 8/12
USPC 250/338.1; 250/206

(57) ABSTRACT

An apparatus and method for monitoring a card slot is provided. The apparatus is for monitoring a card slot for the presence of unauthorised objects or devices and comprises a photon coupled interrupter having a light source configured for placement at a first side of the card slot to be monitored, the light source being configured to emit light across the card slot; a light sensor configured for placement at a side of the card slot opposite to the first side, the light sensor being configured to sense light from the light source that has propagated across the card slot; and control circuitry for controlling the light source to emit light and for determining the presence of an object or device in the card slot from a signal output from the light sensor.

### TECHNICAL FIELD OF THE INVENTION

The invention relates to an apparatus and method for monitoring a card slot, and in particular to an apparatus and method for monitoring a card slot for the presence of unauthorised objects or devices.

### BACKGROUND TO THE INVENTION

Fraudulent use of bank and other payment cards is increasing. Following the introduction of cards with Chip-and-PIN technology, fraudsters have developed new techniques for obtaining the information stored in the card and the user's PIN.

One such technique, which is typically used on an automatic teller machine, ATM, (although it can also be used on other devices into which cards can be inserted), is called card entrapment.

The fraudster will typically place a small mechanical device, for example a Lebanese loop, into the card slot on an ATM or other card terminal to trap a card that is inserted into the ATM or card terminal by a user. The fraudster can also use some means (e.g. video streaming) for monitoring or recording the user's PIN as they type it into the ATM or card terminal.

The mechanical device prevents the card from being ejected from the ATM or card terminal. When the user leaves the ATM or card terminal, the fraudster can try to carry out a fraudulent transaction on the user's account using the retained card and observed PIN and/or retrieve the mechanical device and card for later use in a fraudulent transaction.

These mechanical devices can consist of a face plate that can be mounted against the card reader slot and an attached loop of material. The loop, which is used to trap the card, can be made of varying materials including, x-ray film, fishing line or dental floss and it is inserted through the card reader slot into the card transport.

In order to try and detect the use of these devices, Wincor Nixdorf International GmbH have developed an automated teller machine having at least one camera for detecting manipulation attempts. This is described in WO 2010/121953. The camera can be integrated in a card entry slot and positioned just inside the automated teller machine for capturing images of the interior region of the machine. Lighting can be provided for illuminating the interior region in order to improve the image.

However, the materials used in the above-described card entrapment devices can be very small or very fine (e.g. fishing line or dental floss), and as a result, the Wincor solution cannot reliably detect when such materials have been inserted into a card slot.

Therefore, there is a need for an improved apparatus for monitoring a card slot that can reliably detect the very small or very fine materials used in current card entrapment devices.

### SUMMARY OF THE INVENTION

According to a first aspect of the invention, there is provided an apparatus for monitoring a card slot for the presence of unauthorised objects or devices, the apparatus comprising a photon coupled interrupter having a light source configured for placement at a first side of the card slot to be monitored, the light source being configured to emit light across the card slot; a light sensor configured for placement at a side of the card slot opposite to the first side, the light sensor being configured to sense light from the light source that has propagated across the card slot; and control circuitry for controlling the light source to emit light and for determining the presence of an object or device in the card slot from a signal output from the light sensor.

The use of a photon coupled interrupter in an apparatus for monitoring a card slot is particularly advantageous since it allows very small or very fine objects in the card slot to be detected (since even a very small object in the slot will block or obscure some of the light emitted by the light source). In particular, it is possible to detect an object of the order of 0.2 mm in size anywhere in the monitored region. The photon coupled interrupter is also able to work reliably in a variety of different, and changing, ambient light levels (since the light sensor is configured to detect photons having a specific wavelength of light). In addition, the precise nature of the photon coupled interrupter means that it is very difficult for a fraudster to try and circumvent the protection provided by the invention. For example, it will not be possible for the fraudster to introduce a card entrapment device that includes its own light source into the slot (the light source being intended to trick the light sensor into determining that the slot is clear by maintaining the levels of light being received at the light sensor), since the precise amount and wavelength of the photons emitted by the light source will not be known or easily replicated.

In particular embodiments of the invention, the photon coupled interrupter further comprises a first optical component for receiving the light emitted by the light source and for directing the emitted light across the card slot. Preferably, the first optical component is configured to direct the emitted light across the full height and width, or substantially the full height and width, of the card slot.

In some embodiments, the first optical component is configured to receive the light emitted by the light source and to generate collimated light or narrowly-spaced parallel beams of light. In these embodiments, the first optical component preferably comprises a lens, for example a positive converging lens or a collimating lens.

In alternative embodiments, the first optical component is configured to receive the light emitted by the light source and to generate a gradually diverging beam of light. In these embodiments, the first optical component preferably comprises a prism.

In yet further alternative embodiments, the first optical component comprises one or more fibre optic scopes.

In particular embodiments, the photon coupled interrupter further comprises a second optical component for collecting light at the side of the card slot opposite the first side and for directing the collected light to the light sensor. In these embodiments, the second optical component preferably comprises a lens, for example a positive converging lens or a collimating lens. Alternatively, the second optical component can comprise one or more fibre optic scopes.

In preferred embodiments, the light source is configured to emit infrared light or laser light.

In some embodiments, the control circuitry is configured to determine the presence of an unauthorised object or device in the card slot if a signal output from the light sensor indicates an object or device is present in the card slot for more than a predetermined time period.

According to a second aspect of the invention, there is provided a card reader comprising a card slot into which a card can be inserted and an apparatus as described above for monitoring the card slot for the presence of an unauthorised object or device.

According to a third aspect of the invention, there is provided an automatic teller machine, ATM, comprising a card slot into which a card can be inserted and an apparatus as claimed in any preceding claim for monitoring the card slot for the presence of an unauthorised object or device.

According to a fourth aspect of the invention, there is provided a method for monitoring a card slot for the presence of unauthorised objects or devices, the method comprising placing a light source of a photon coupled interrupter at a first side of the card slot to be monitored, the light source being configured to emit light across the card slot; placing a light sensor of a photon coupled interrupter at a side of the card slot opposite to the first side, the light sensor being configured to sense light from the light source that has propagated across the card slot; operating the light source to emit light across the card slot towards the light sensor; and detecting the presence of an object or device in the card slot on the basis of the amount of light received by the light sensor.

### BRIEF DESCRIPTION OF THE DRAWINGS

Various exemplary embodiments of the invention will now be described, by way of example only, with reference to the accompanying figures, in which:

FIG. 1 is an illustration of an automated teller machine, ATM, to which the invention can be applied;

FIG. 2 is an illustration of a motorised card reader for an ATM;

FIG. 3 is a block diagram of an apparatus according to an embodiment of the invention;

FIG. 4 is an illustration of some of the components of the apparatus according to the invention arranged at a card slot;

FIG. 5 is an illustration showing an apparatus according to a first embodiment of the invention at a card slot;

FIG. 6 is an illustration showing an apparatus according to a second embodiment of the invention at a card slot; and

FIG. 7 is a flow chart illustrating a method of detecting objects according to the invention.

### DETAILED DESCRIPTION OF EMBODIMENTS OF THE INVENTION

Although embodiments of the invention will be described below with reference to automated teller machines, ATMs (which are also known as automated banking machines), and the card readers used therein, it will be appreciated that the invention can be applied to any terminal or device into which a user can insert a bank or payment card through a slot. Furthermore, although the card readers described below are motorised card readers which draw the inserted card further into the machine to read the information stored on the card, the invention can be used with other types of card readers, for example dip card readers, in which the user places the card in the required position.

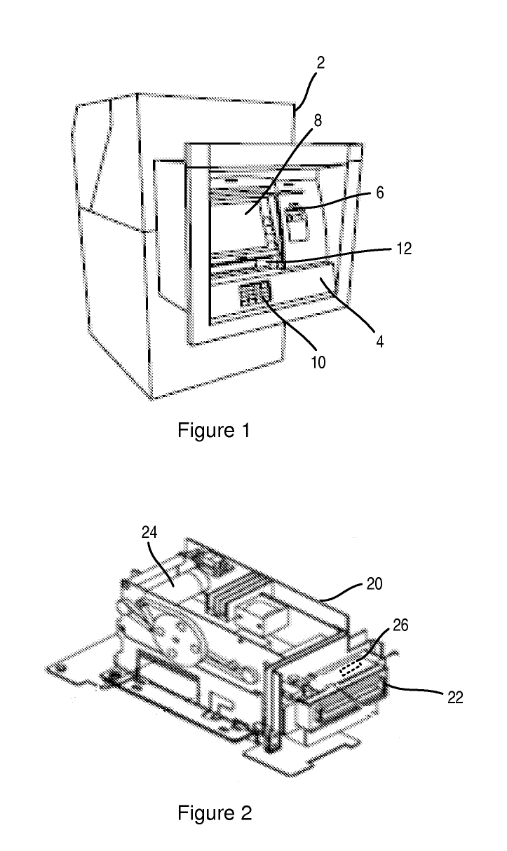

FIG. 1 is an illustration of a conventional automated teller machine, ATM. The ATM 2 comprises a fascia 4 having an external card slot 6 into which a user can insert their card, a display 8 for presenting information and/or options to a user, a keypad 10 for allowing a user to input their PIN and select a required option and a dispensing slot 12 from which money is dispensed to the user. The external card slot 6 is typically of the order of 3 mm high and 50 mm wide.

ATMs frequently include motorised card readers which draw a card inserted into the external card slot 6 by a user further into the ATM 2. FIG. 2 shows an exemplary motorised card reader 20. The card reader 20 is mounted inside the body of the ATM 2 so that a card slot 22 of the card reader 20 is positioned adjacent the external card slot 6 of the ATM 2. On sensing the insertion of a card into the card slot 22 via the external card slot 6, a motor 24 in the card reader 20 is activated to pull the card further into the ATM 2 and card reader 20. As the card is pulled into and through the card reader 20, a magnetic strip read head 26 (not directly visible in FIG. 2) reads the information stored in a magnetic strip on the card.

As described in the Background section, fraudsters can mount a device having a face plate and a loop of material against the external card slot 6. The device is primed for use by passing the loop of material through the external card slot 6 in the ATM 2 and the card slot 22 into the body of the card reader 20, so that the loop of material is ready to trap the next card that is inserted into the external card slot 6.

The invention provides an apparatus that can be used to monitor the external card slot 6 of the ATM 2 (or alternatively the card slot 22 of the card reader 20, which is just inside the ATM 2, or an internal part of the card reader 20 through which a card can pass) for the presence of unauthorised objects or devices, such as the loop of material used in the above-described card entrapment devices.

Briefly, the apparatus includes a means for generating light in a predetermined beam or pattern in the region to be monitored (i.e. the slot 6, 22 or the body of the card reader 20) and a sensor or array of sensors for monitoring the light beam or pattern to detect the presence of an object or device in the monitored region. The sensor or sensor array will detect changes in the light beam or pattern (specifically a reduction or interruption in the level of light received at the sensor) caused by an object or device being present in the monitored region. If the apparatus detects an unauthorised object or device in the monitored region, the apparatus can cause the ATM 2 to be taken offline (i.e. the ATM 2 can prevent cards being inserted by other users) until the unauthorised object or device is removed from the monitored region, and/or alert an operator of the ATM 2 that an unauthorised object or device is present in the ATM 2.

It will be appreciated that the apparatus will also detect the presence of a card when it is placed in the external card slot 6 and card slot 20 before it is pulled further into the card reader 20. As a result, the apparatus can employ a timer in order to help distinguish between authorised objects (i.e. cards) and unauthorised objects. If a detected object remains in the external card slot 6, card slot 22 or other monitored portion of the card reader 20 for longer than a predetermined time period, then the apparatus can determine that the object is unauthorised. The predetermined time period can be set based on the time that a card is typically expected to be in the monitored region (for example a few seconds) or the time that a typical user transaction with the ATM 2 is expected to take (for example one to two minutes).

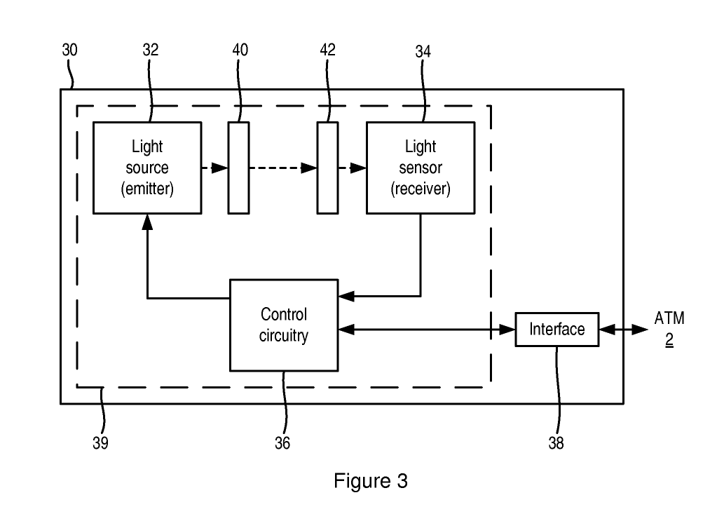

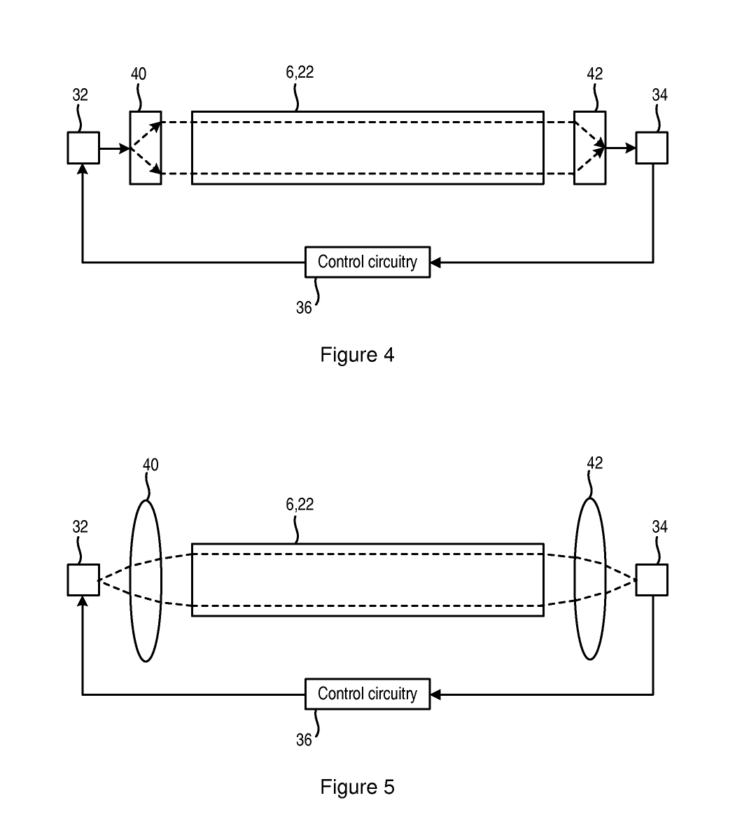

A block diagram of an apparatus according to the invention is shown in FIG. 3. FIG. 4 illustrates some of the components of the apparatus according to the invention arranged at a card slot 6, 22. The apparatus 30 comprises a light source 32 that is positioned at one side of the external card slot 6 or card slot 22 and that emits light in a predetermined beam or pattern across the width and height of the external slot 6 or slot 22 (in other words across the cross-section of the slot 6 or 22). The apparatus 30 also comprises a light sensor 34 that is to be positioned on the opposite side of the external card slot 6 or card slot 22 and that detects the light beam or light pattern produced by the light source 32. The light sensor 34 may comprise a single sensor or an array of separate sensors. The region between the light source 32 and light sensor 34 encompassing the external slot 6 or slot 22 (or another part of the body of the card reader 20 through which a card can pass and in which an unauthorised object can be placed) is referred to as the monitored region.

The apparatus 30 also includes control circuitry 36 that controls the light source 32 and that processes the signals output by the light sensor 34 to determine if there is an object in the monitored region between the light source 32 and light sensor 34. The apparatus 30 further comprises an interface 38 connected to the control circuitry 36 that allows the control circuitry 36 to send an alert signal or other indication to the processing unit of the ATM 2 indicating that an unauthorised object or device is present in the external card slot 6 or card slot 22 (as appropriate depending on the positioning of the apparatus 30 in the ATM 2). The control circuitry 36 may implement the timer described above in order to distinguish between authorised objects and unauthorised objects placed in the monitored region.

The light source 32, light sensor 34 and control circuitry 36 are configured so that they form and operate as a photon coupled interrupter 39. As such, the light source 32 emits a known quantity of photons per unit time at a predetermined wavelength or wavelengths on one side of the slot 6, 22, and the control circuitry 36 analyses the signal output by the light sensor 34 to determine if all of the emitted photons are received by the light sensor 34 at the opposite side of the slot 6, 22.

In use, the apparatus 30 can be attached or mounted to the inside of the fascia 4 of the ATM 2 so that the apparatus 30 monitors the external card slot 6 from the inside of the ATM 2, or alternatively, the apparatus 30 can be integrated into the card reader 20 so that it monitors the slot 22 or some part of the body of the card reader 20 through which a card passes when it is inserted into the ATM 2.

The use of a photon coupled interrupter 39 for monitoring the slot 6, 22 is particularly advantageous since it allows very small or very fine objects in the slot 6, 22 to be detected (since even a very small object in the slot 6, 22 will block or obscure some of the photons emitted by the light source 32). In particular, it is possible to detect an object of the order of 0.2 mm in size anywhere in the monitored region. A photon coupled interrupter 39 is also able to work reliably in a variety of different, and changing, ambient light levels (since the light sensor 34 is configured to detect photons having a specific wavelength of light). In addition, the precise nature of the photon coupled interrupter 39 means that it is very difficult for a fraudster to try and circumvent the protection provided by the invention. For example, it will not be possible for the fraudster to introduce a card entrapment device that includes its own light source into the slot 6, 22 (the light source being intended to trick the light sensor 34 into determining that the slot 6, 22 is clear by maintaining the levels of light being received at the light sensor 34), since the precise amount and wavelength of the photons emitted by the light source 32 will not be known or easily replicated.

In one embodiment, the light source 32 is an infrared light source and the light sensor 34 is an infrared light sensor or an array of infrared sensors. In an alternative embodiment, the light source 32 is a laser light source and the light sensor 34 is a sensor or array of sensors suitable for detecting laser light. Those skilled in the art will appreciate other types of light source and light sensor that can be used in accordance with the invention to generate the required light beam or light pattern.

In order for the photon coupled interrupter 39 to monitor the, or almost all of the, full cross-section of the slot 6, 22, a first optical component 40 is provided to ‘shape’ the light emitted by the light source 32 so that it is guided across substantially the full height and width of the slot 6, 22. A second optical component 42 is provided to collect the light at the opposite end of the slot 6, 22 and direct it to the light sensor 34.

In some embodiments, the first optical component 40 produces collimated light or narrowly-spaced parallel beams of light. In other embodiments, the first optical component 40 produces a gradually diverging beam of light that covers the full, or a substantial portion of the, height of the slot 6, 22.

A first specific embodiment of the invention is shown in FIG. 5. In this embodiment, the first optical component 40 comprises a lens that produces a collimated light pattern across at least the height of the slot 6, 22 from the light emitted by the light source 32. The second optical component 42 also comprises a lens that receives the collimated light and focuses the light onto the light sensor 34.

In this embodiment, the first and second optical components 40, 42 can comprise a positive converging lens or a collimating lens.

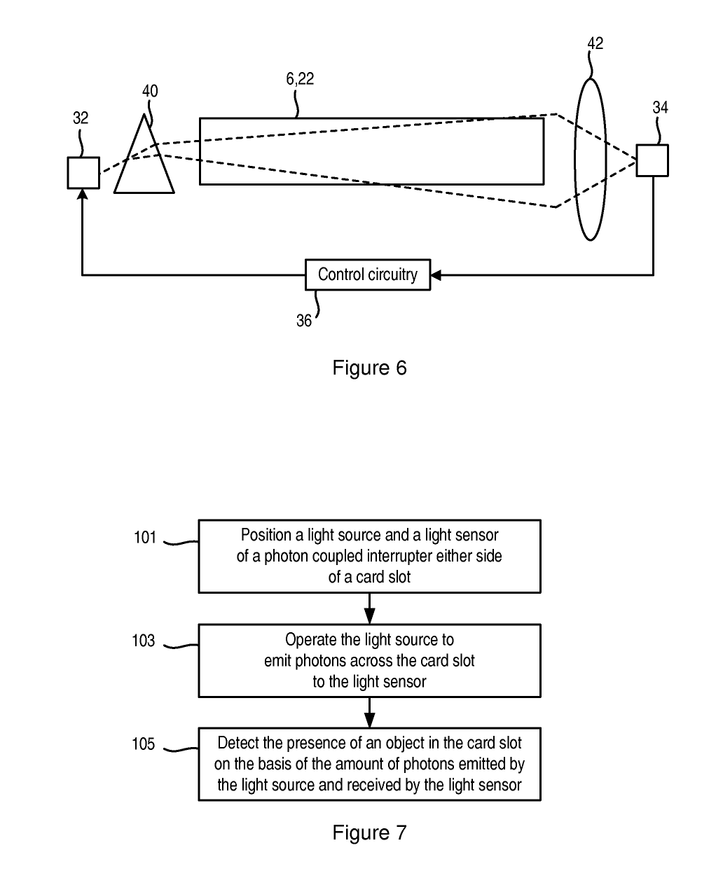

A second specific embodiment of the invention is shown in FIG. 6. In this embodiment, the first optical component 40 comprises a prism that produces a gradually diverging beam of light across at least the height of the slot 6, 22 from the light emitted by the light source 32. The second optical component 42 comprises a lens that receives the gradually diverging beam of light and focuses the light onto the light sensor 34.

In this embodiment, the first optical component 40 can be a refracting prism and the second optical component 42 can be a positive converging lens.

In alternative embodiments of the invention, fibre optic scopes can be used to generate the predetermined pattern of light across the card slot 6, 22.

It will be appreciated that, in some embodiments of the invention, the first and second optical components 40, 42 can each comprise more than one optical component and/or different types of optical components (for example lenses, prisms and fibre optic scopes) to generate the required light pattern across the monitored region.

A method of monitoring a card slot for the presence of unauthorised objects or devices is shown in FIG. 7. In a first step (step 101) a light source 32 and a light sensor 34 of a photon coupled interrupter 39 are positioned either side of a region to be monitored (i.e. an external card slot 6, card slot 22 or part of the body of the card reader 20).

The light source 32 is then operated to emit specific amounts of photons having a predetermined wavelength or wavelengths across the slot towards the light sensor 34 (step 103). As described above, optical components 40, 42 can be used to generate a light pattern from the emitted photons across all, or substantially all, of the region to be monitored in order to detect the presence of objects in any part of the monitored region.

The presence of objects in the monitored region is detected from a comparison of the amount of photons emitted by the light source 32 to the amount of photons received by the light sensor 34 (step 105). The presence of an object in the monitored region can be determined where the difference between the amount of photons emitted by the light source 32 and the amount of photons received by the light sensor 34 is greater than a threshold value.

There is therefore provided an apparatus and method for monitoring a card slot for the presence of unauthorised objects or devices.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. An apparatus for monitoring a card slot for the presence of unauthorised objects or devices, the apparatus comprising:
a photon coupled interrupter having:
a light source configured for placement at a first side of the card slot to be monitored, the light source being configured to emit light across the card slot;
a light sensor configured for placement at a side of the card slot opposite to the first side, the light sensor being configured to sense light from the light source that has propagated across the card slot; and
control circuitry for controlling the light source to emit light and for determining the presence of an object or device in the card slot from a signal output from the light sensor.

2. An apparatus as claimed in claim 1, wherein the photon coupled interrupter further comprises:
a first optical component for receiving the light emitted by the light source and for directing the emitted light across the card slot.

3. An apparatus as claimed in claim 2, wherein the first optical component is configured to direct the emitted light across the full height and width, or substantially the full height and width, of the card slot.

4. An apparatus as claimed in claim 2, wherein the first optical component is configured to receive the light emitted by the light source and to generate collimated light or narrowly-spaced parallel beams of light.

5. An apparatus as claimed in claim 4, wherein the first optical component comprises a lens.

6. An apparatus as claimed in claim 5, wherein the first optical component comprises a positive converging lens or a collimating lens.

7. An apparatus as claimed in claim 2, wherein the first optical component is configured to receive the light emitted by the light source and to generate a gradually diverging beam of light.

8. An apparatus as claimed in claim 7, wherein the first optical component is a prism.

9. An apparatus as claimed in claim 1, wherein the first optical component comprises one or more fibre optic scopes.

10. An apparatus as claimed in claim 1, the photon coupled interrupter further comprising:
a second optical component for collecting light at the side of the card slot opposite the first side and for directing the collected light to the light sensor.

11. An apparatus as claimed in claim 10, wherein the second optical component comprises a lens.

12. An apparatus as claimed in claim 11, wherein the second optical component comprises a positive converging lens or a collimating lens.

13. An apparatus as claimed in claim 10, wherein the second optical component comprises one or more fibre optic scopes.

14. An apparatus as claimed in claim 1, wherein the light source is configured to emit infrared light or laser light.

15. An apparatus as claimed in claim 1, wherein the control circuitry is configured to determine the presence of an unauthorised object or device in the card slot if a signal output from the light sensor indicates an object or device is present in the card slot for more than a predetermined time period.

16. A card reader, comprising:
a card slot into which a card can be inserted; and
an apparatus as claimed in claim 1 for monitoring the card slot for the presence of an unauthorised object or device.

17. An automatic teller machine, ATM, comprising:
a card slot into which a card can be inserted; and
an apparatus as claimed in claim 1 for monitoring the card slot for the presence of an unauthorised object or device.

18. A method for monitoring a card slot for the presence of unauthorised objects or devices, the method comprising:
placing a light source of a photon coupled interrupter at a first side of the card slot to be monitored, the light source being configured to emit light across the card slot;
placing a light sensor of a photon coupled interrupter at a side of the card slot opposite to the first side, the light sensor being configured to sense light from the light source that has propagated across the card slot;
operating the light source to emit light across the card slot towards the light sensor; and
detecting the presence of an object or device in the card slot on the basis of the amount of light received by the light sensor.

19. An apparatus for monitoring a card slot for the presence of unauthorised objects or devices, substantially as hereinbefore described, with reference to, and as shown in, FIGS. 3, 4, 5 and 6 of the accompanying drawings.

20. A method for monitoring a card slot for the presence of unauthorised objects or devices, substantially as hereinbefore described, with reference to, and as shown in, FIG. 7 of the accompanying drawing.
